(19) United States
(12) Patent Application Publication
(10) Pub. No.: US 2026/0131593 A1
(43) Pub. Date: May 14, 2026

(54) CUSTOMIZATION KIT OF A STATIONERY ITEM PROVIDED WITH A SHAFT

(71) Applicant: CLEMENTONI S.P.A., Recanati (MC) (IT)

(72) Inventors: Sara GALVANI, Macerata (IT); Claudia CARDINALI, Porto Sant’Elpidio (FM) (IT)

(21) Appl. No.: 19/378,419

(22) Filed: Nov. 4, 2025

(30) Foreign Application Priority Data
Nov. 14, 2024 (IT) 102024000025719

(51) Int. Cl. B43M 99/00; B43K 29/007

(52) U.S. Cl. CPC B43M 99/008; B43K 29/007

(57) ABSTRACT

A kit comprises a plurality of stationery items comprising a shaft, a plurality of decorative elements comprising a body and a hole suitable for being fitted onto the shaft of the stationery items in such a way to customize the stationery item, a workstation configured to support the shaft of the stationery item for assembling the decorative elements on the shaft of the stationery item, and a stand for displaying and containing purposes configured to house said customized stationery items and the decorative elements.

### CROSS-REFERENCE TO RELATED APPLICATIONS

Not applicable.

### FIELD OF THE INVENTION

The present invention relates to the field of children's toys and refers to a kit for customizing a stationery item provided with a shaft. The term “stationery item” refers to an item that is suitable for writing, coloring, and highlighting, such as a pen, a pencil, a pencil lead, a crayon, a marker, and the like.

### BACKGROUND OF THE INVENTION

Various types of kits for customizing a pen are known in the field of children’s toys, wherein the pen has a transparent cylinder that is filled with water and colored objects, such as beads, spangles, holographic decorations, and the like.

However, such a type of customization kit has the disadvantage of not being suitable for small children, as there is a risk that they may swallow the water with the colored beads.

Moreover, with such a type of customization kit, the customization of the pen is performed randomly, and does not allow to obtain an ad hoc customization according to a preset pattern.

US2002/044815A1 discloses a writing instrument according to the preamble of claim 1. Such a writing instrument has rotating beads of various shapes and sizes that are positioned one on top of the other to form logos, designs, words, or messages for promotional or advertising purposes. The beads offer an ergonomically pleasant feeling to the user and, at the same time, they are a fun element.

### SUMMARY OF THE INVENTION

The purpose of the present invention is to eliminate the drawbacks of the prior art by providing a customization kit for stationery items that is reliable, safe, and suitable for being used even by small children.

Another purpose is to provide such a customization kit that is versatile and capable of offering different types of customizations that are made ad hoc and preset according to a predefined pattern.

Yet another purpose is to provide such a customization kit that is practical and easy for a child to use.

These purposes are achieved in accordance with the invention with the characteristics of the attached independent claim 1.

Advantageous embodiments of the invention appear from the dependent claims.

### BRIEF DESCRIPTION OF DRAWINGS

Further features of the invention will become clearer from the following detailed description, which refers to a purely exemplary and therefore non-limiting embodiment illustrated in the accompanying drawings, wherein:

FIG. 1 is a perspective view illustrating the customization kit for stationery items according to the invention.

FIG. 2 is an exploded perspective view illustrating a stand of the kit in FIG. 1.

FIG. 3 is a perspective view of the stand of FIG. 2 in assembled condition.

FIG. 4 is an exploded perspective view illustrating a stationery item, such as a pen.

FIG. 5 is a perspective view of the stationery item of FIG. 4 in assembled condition.

FIG. 6 is an exploded perspective view illustrating a workstation with a shaft of the stationery item.

FIG. 7 is a perspective view illustrating the workstation of FIG. 6 in assembled condition, with the shaft of the stationery item disposed in vertical position in the workstation.

FIG. 8 is the same view as FIG. 7 illustrating the shaft of the stationery item disposed in horizontal position in the workstation.

FIG. 9 is a perspective view illustrating various decorative elements and stickers.

FIG. 10 is a perspective view illustrating the workstation during the assembly of the decorative elements on the shaft disposed in horizontal position.

FIG. 11 is a perspective view illustrating the workstation, wherein the decorative elements are fitted onto the shaft.

FIG. 12 is a perspective view illustrating the workstation, wherein the shaft with the decorative elements is in vertical position.

FIG. 13 is a perspective view illustrating the shaft with the decorative elements that has been removed from the workstation and an exploded view of the parts of the stationery item.

FIG. 14 is a perspective view illustrating the stationery item of FIG. 13 assembled and customized with the decorative elements.

FIG. 15 is a perspective view illustrating the stationery item of FIG. 14 customized with stickers and second decorative elements attached to the cap.

FIG. 16 is a perspective view illustrating three different customizations of stationery items with decorative elements.

FIG. 17 is the same view as FIG. 16, except for it illustrates three examples of different customizations of stationery items with stickers and second decorative elements attached to the cap.

### DETAILED DESCRIPTION OF THE INVENTION

With the aid of the Figures, the kit according to the invention, which is comprehensively indicated with reference numeral 1, is described.

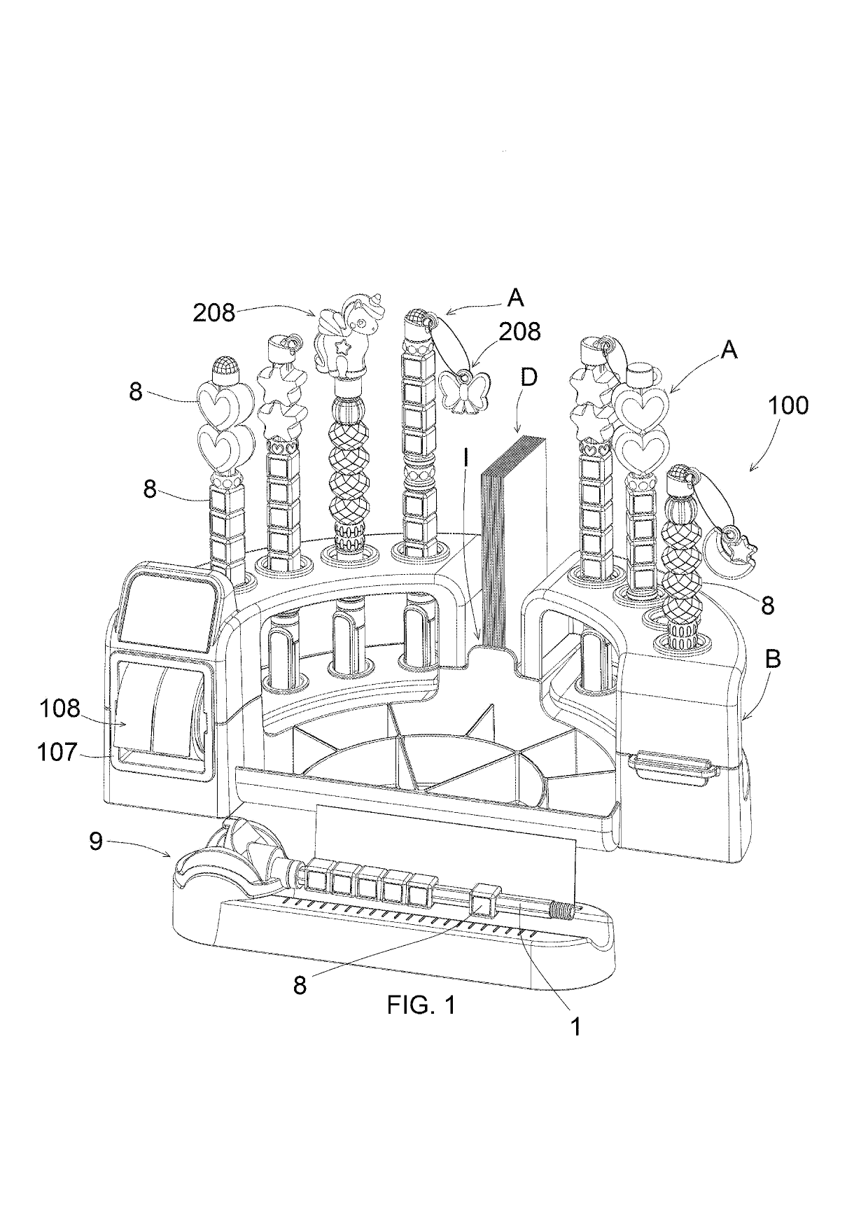

Now, with reference to FIG. 1, the kit (100) comprises:

a plurality of stationery items (A).

a plurality of decorative elements (8) suitable for being fitted onto the stationery items (A) to customize them;

a workstation (9) for customizing the stationery item (A) with the decorative elements (8); and

a stand (B) used for displaying and containing the customized stationery items and storing the decorative elements (8).

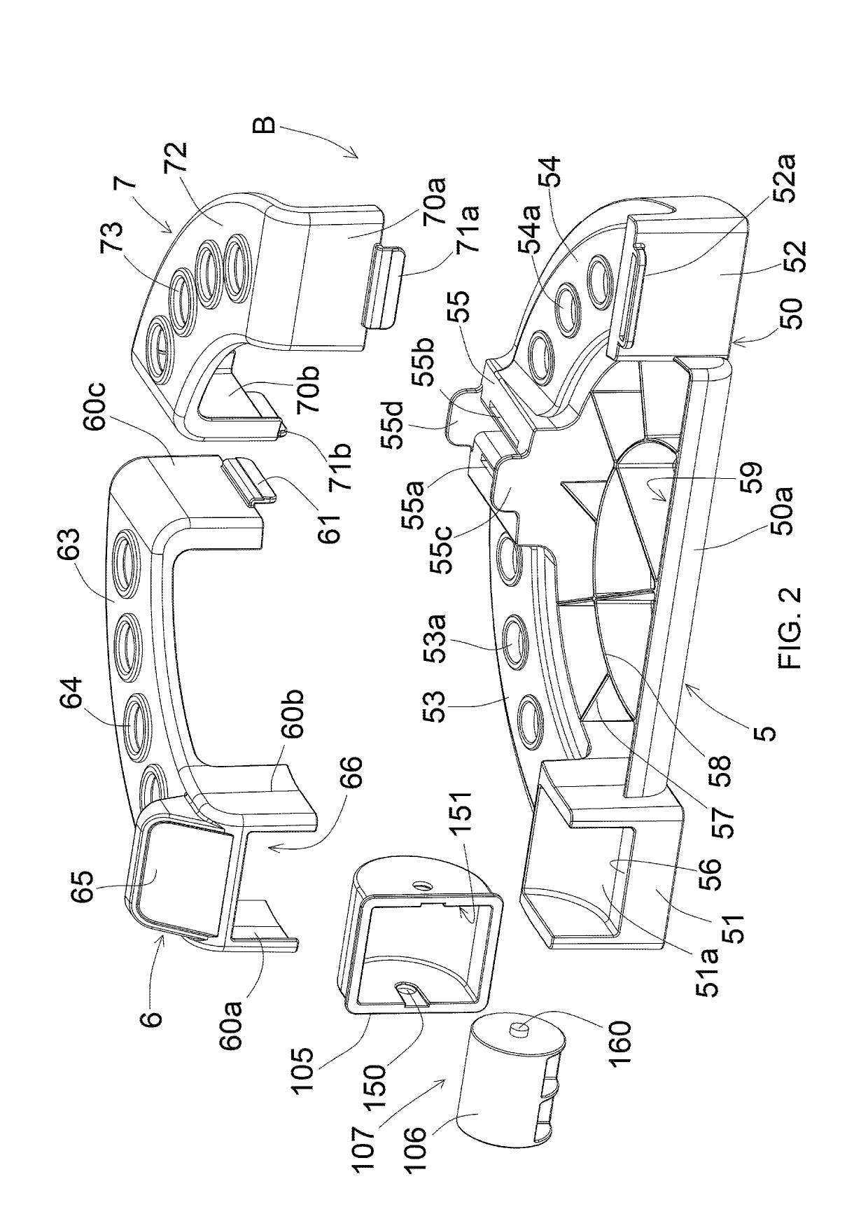

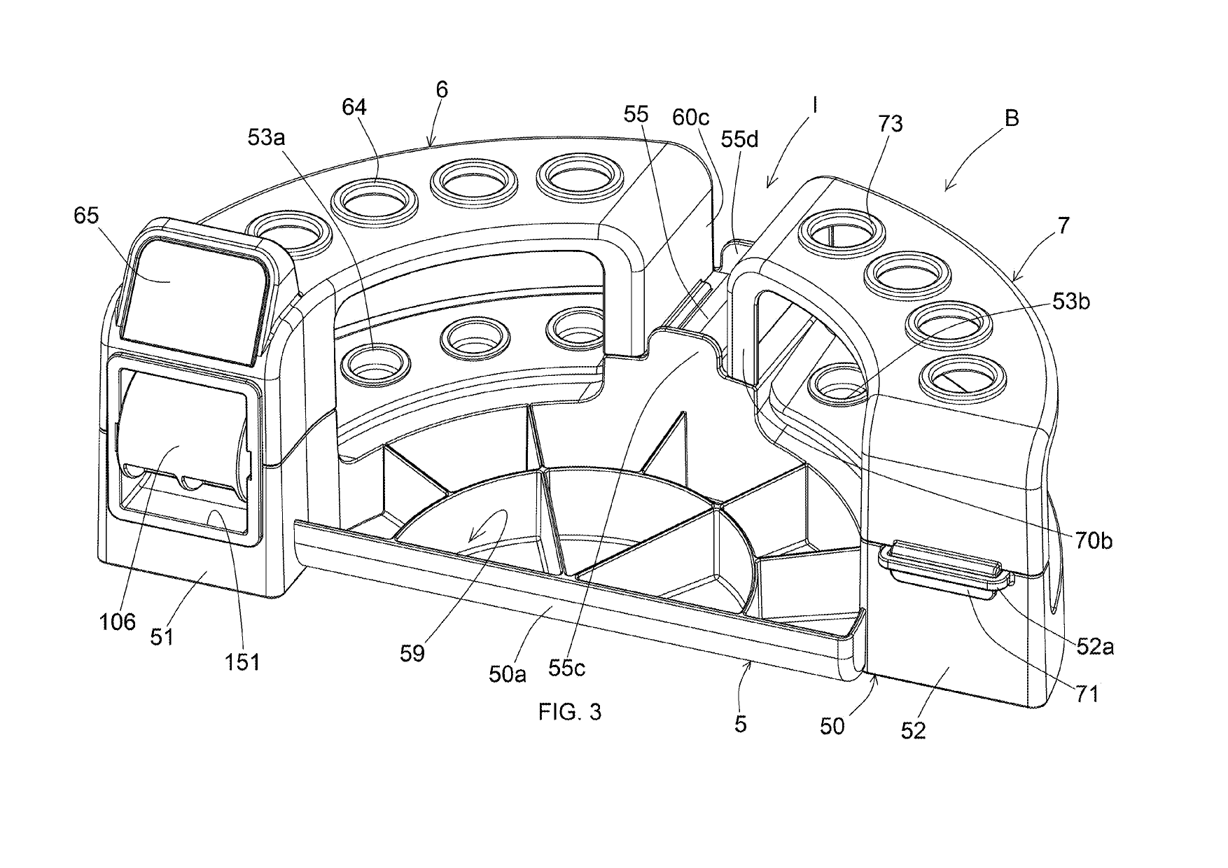

With reference to FIGS. 2 and 3, the stand (B) is of a modular type and comprises several modules suitable for being assembled to form the stand. The stand (B) comprises a base (5) and a first module (107), a second module (6), and a third module (7) that can be assembled on the base (5).

The base (5) comprises a bottom (50) in the shape of a semicircular plate. A central front wall (50a) rises from the bottom (50), ending at its left and right ends with a box (51) and a raised wall (52), respectively.

The box (51) has a seat (51a) with a front window (56) with a U-shape. The raised part (52) has an engagement seat (52a).

A first support block (53) and a second support block (54) are peripherally disposed on the bottom (50) of the base, and separated by a central support block (55). The first and second support blocks are shaped like an arc of a circle.

On the first support block (53) there is a plurality of engagement seats (53a) suitable for accommodating one end of the stationery items (A). The engagement seats (53a) are obtained by means of cylindrical shanks that protrude superiorly from the first support block (53) and are disposed in correspondence with holes of the first support block. By way of example, four engagement seats (53a) are formed on the first support block (53).

On the second support block (54) there is a plurality of engagement seats (54a) suitable for accommodating one end of the stationery items (A). The engagement seats (54a) of the second support block are obtained by means of cylindrical shanks that protrude superiorly from the second support block (54) and are disposed in correspondence with holes in the second support block. By way of example, four engagement seats (54a) are formed on the second support block (54).

The central support block (55) is raised with respect to the first and second support block. The central support block has a first engagement seat (55a) and a second engagement seat (55b) disposed in lateral position. The central support block has a first lug (55c) and a second lug (55d) protruding superiorly from the front and rear edge of the central support block.

A semicircular seat is defined between the support blocks (53, 54, 55) and the front wall (50a), wherein a plurality of partitions (57, 58) is disposed so as to define a plurality of compartments (59) suitable for containing the decorative elements (8). By way of example, an arched partition (58) and radial partitions (57) are used to obtain nine compartments (59).

The first module (107) is suitable for containing stickers (108) (FIG. 1). The first module (107) comprises a lid (105) and a roller (106) rotatably mounted in the lid. The lid (105) has a semi-cylindrical shape with a rectangular opening (151).

The roller (106) has pins (160) that are rotatably engaged in hinge seats (150) of the lid (105). Stickers (108) in the form of strips are wound onto the roller (106) so as to form a roll of stickers contained in the lid (105).

The first module (107) is disposed in the seat (51a) of the box (51) of the base.

The second module (6) is shaped like a bridge with an arched platform (63) supported by two front legs (60a, 60b) and one rear leg (60c).

The two front legs (60a, 60b) form an opening shaped like an inverted “U” (66). The two front legs (60a, 60b) are disposed on the box (51) of the base (51) so that the lid (105) of the first module is closed between the box (51) and the front legs (60a, 60b) of the second module.

An engagement tab (61) protrudes inferiorly from the rear leg (60c) and is engaged in the first engagement seat (55a) of the central support block (55) of the base.

A plurality of holes (64) is formed on the platform (63) of the second module. When the second module (6) is mounted on the base (5), the holes (64) of the platform of the second module are aligned with the engagement seats (53a) of the first support block of the base, so that the stationery items (A) with the decorative elements (8) can be inserted into the holes (64) of the second module and one end of said stationery items can be engaged in the engagement seats (53a) of the first support block of the base.

The third module (7) has the shape of a bridge with an arcuate platform (72) supported by a front leg (70a) and a rear leg (70b).

An engagement tab (71a) protrudes inferiorly from the front leg (70a) and is engaged in the engagement seat (52a) of the raised wall (52) of the base. An engagement tab (71b) protrudes inferiorly from the rear leg (70b) and is engaged in the second locking seat (55b) of the central support block (55) of the base.

With reference to FIG. 3, a seat (I) is formed on the central support block (55) between the front and rear tabs (55c, 55d) of the central block and the rear legs (60c, 70b) of the second and third module.

With reference to FIG. 1, the seat (I) of the stand is suitable for accommodating reference cards (D) that will be described below.

A plurality of holes (73) is formed on the platform (72) of the third module. When the third module (7) is mounted on the base (5), the holes (73) of the platform of the third module are aligned with the engagement seats (54b) of the second support block of the base, so that the stationery items (A) with the decorative elements (8) can be inserted into the holes (73) of the third module and one end of said stationery items can be engaged in the engagement seats (53b) of the second support block of the base.

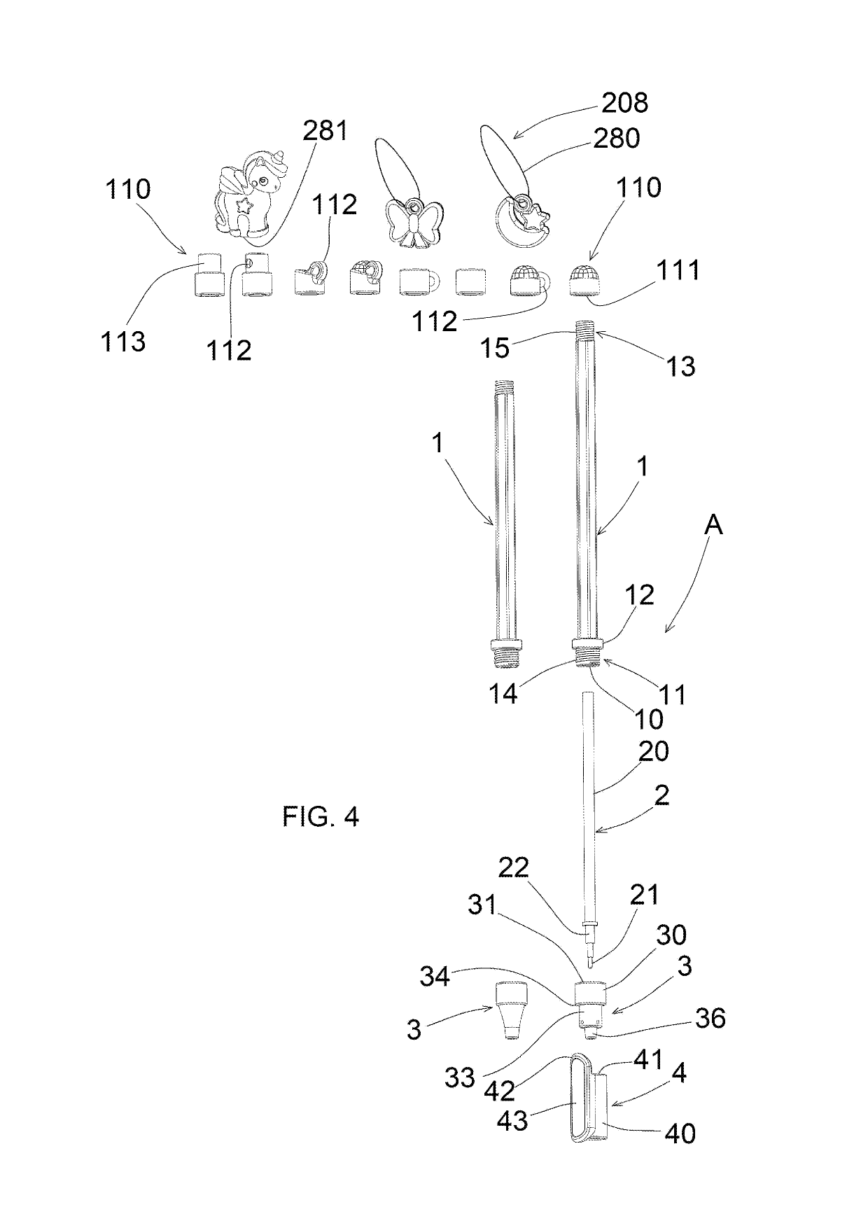

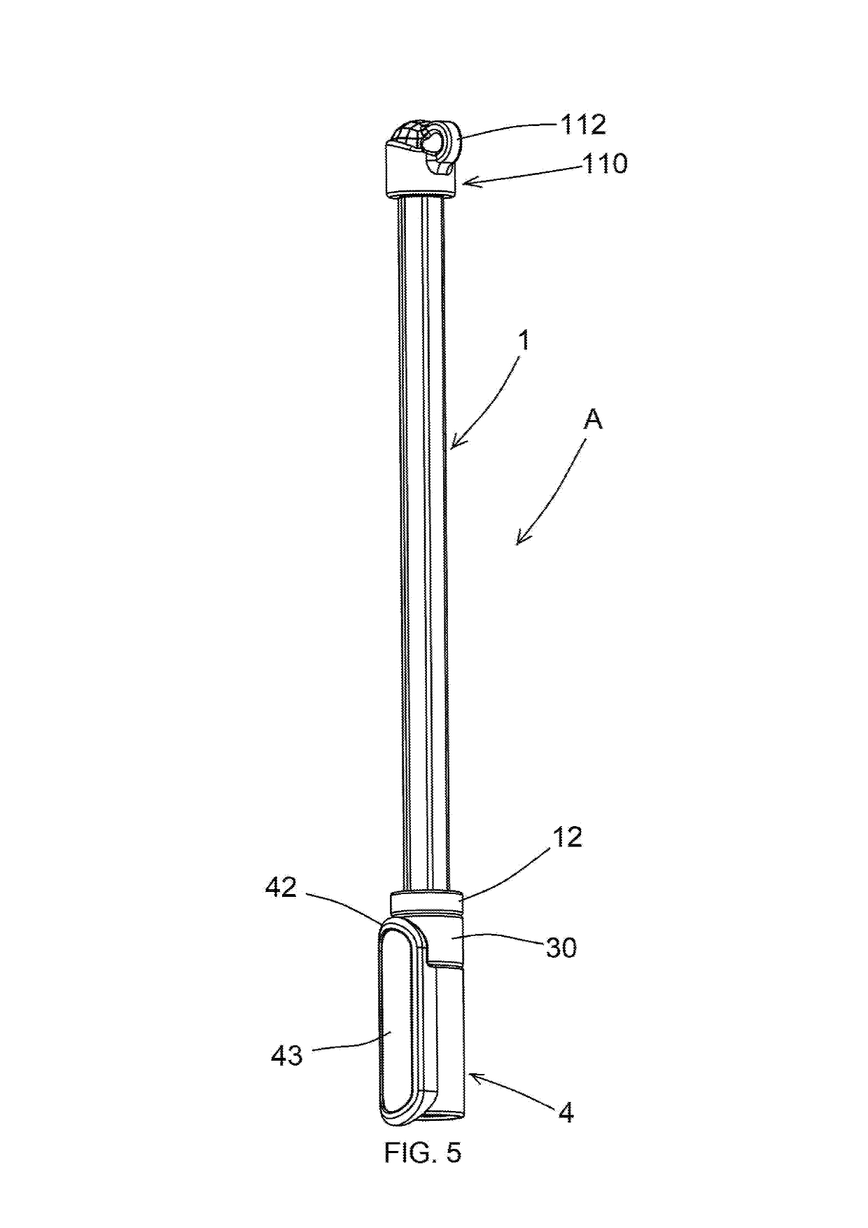

With reference to FIGS. 4 and 5, each stationery item (A) comprises

a shaft (1);

a writing element (2) insertable into the shaft (1);

a retaining tip (3) that can be fitted on a front part of the shaft;

a cap (110) that can be fitted on a rear part of the shaft; and

a plug (4) that can be fitted on the retaining tip (3).

The shaft (1) has a prismatic section, such as a hexagonal or pentagonal section.

The shaft (1) has an axial channel (10) for housing the writing element (2). The shaft (1) has a front attachment (11) for connection to the retaining tip (3). The front attachment (11) is of threaded type with an external thread (14). A collar (12) protrudes from the shaft in correspondence with the front attachment (11). The shaft (1) has a rear attachment (13) for connection to the cap (110).

The rear attachment (13) is of threaded type with an external thread (15). FIG. 4 shows two shafts of different lengths.

The writing element (2) can be a refill of a pen or marker, but it can also be a pencil, a crayon, or a pencil lead.

In any case, the writing element (2) has a substantially cylindrical body (20) with a writing tip (21) suitable for writing on a surface. A collar (22) protrudes externally from the body (20) near the writing tip (21).

FIG. 4 illustrates the case in which the body (20) is a refill, i.e., a reservoir containing a coloring substance, such as ink, which reaches the writing tip (21).

The retaining tip (3) comprises a cylindrical portion (30) with an axial channel (31) having an internal thread suitable for engaging with the external thread (14) of the front attachment of the shaft. A tang (33) with a smaller diameter than the cylindrical portion (30) protrudes inferiorly from the cylindrical portion (30) in such a way to form an abutting step (34). A tapered portion (36) protrudes inferiorly from the tang (33) of the tip.

FIG. 4 illustrates two tips (3) that differ only in the shape of the tang (33), which can be cylindrical or tapered.

The body (20) of the writing element is inserted into the axial channel (10) of the shaft, and the internal thread of the retaining tip (3) is screwed into the external thread (14) of the front attachment of the shaft, so that the writing tip (21) of the writing element protrudes from the tapered part (36) of the tip. The collar (22) of the writing element is held between a counter element of the shaft (1) and a counter element of the retaining tip (3).

The cap (110) has an attachment (111) suitable for being attached with the rear attachment (13) of the shaft. The attachment (111) of the cap has an internal thread that is screwed onto the external thread of the rear attachment (13) of the shaft.

The cap (110) comprises fastening means (112) suitable for fastening a loop-shaped thread (280) of a second decorative element (208). The fastening means (112) may be a protruding eyelet or a radial through hole.

The cap (110) comprises coupling means (113) suitable for coupling with coupling means (281) of a second decorative element (208). The coupling means (113) of the cap may be of male type, such as a tang. The coupling means (281) of the second decorative element may be of female type, such as a seat.

FIG. 4 illustrates eight different types of caps (110) and three different examples of types of second decorative elements (208).

The plug (4) comprises a cylindrical body (40) provided with an axial hole (41) suitable for accommodating the tapered portion (36) and the tang (33) of the tip, so that one edge of the plug abuts against the abutment step (34) of the tip.

A wing (42) is connected to the body (40) of the plug and extends longitudinally so as to be positioned outside the cylindrical portion (30) of the tip. The wing (42) has a smooth surface (43).

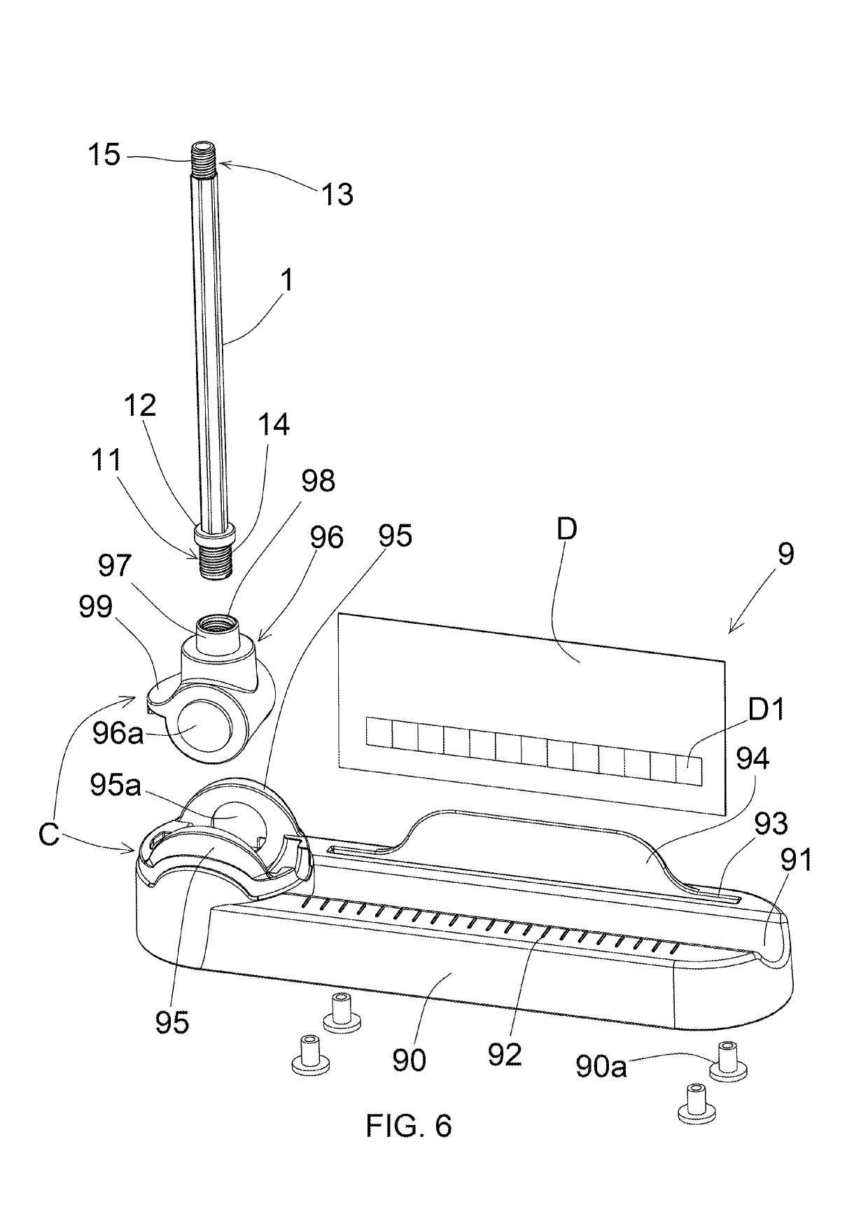

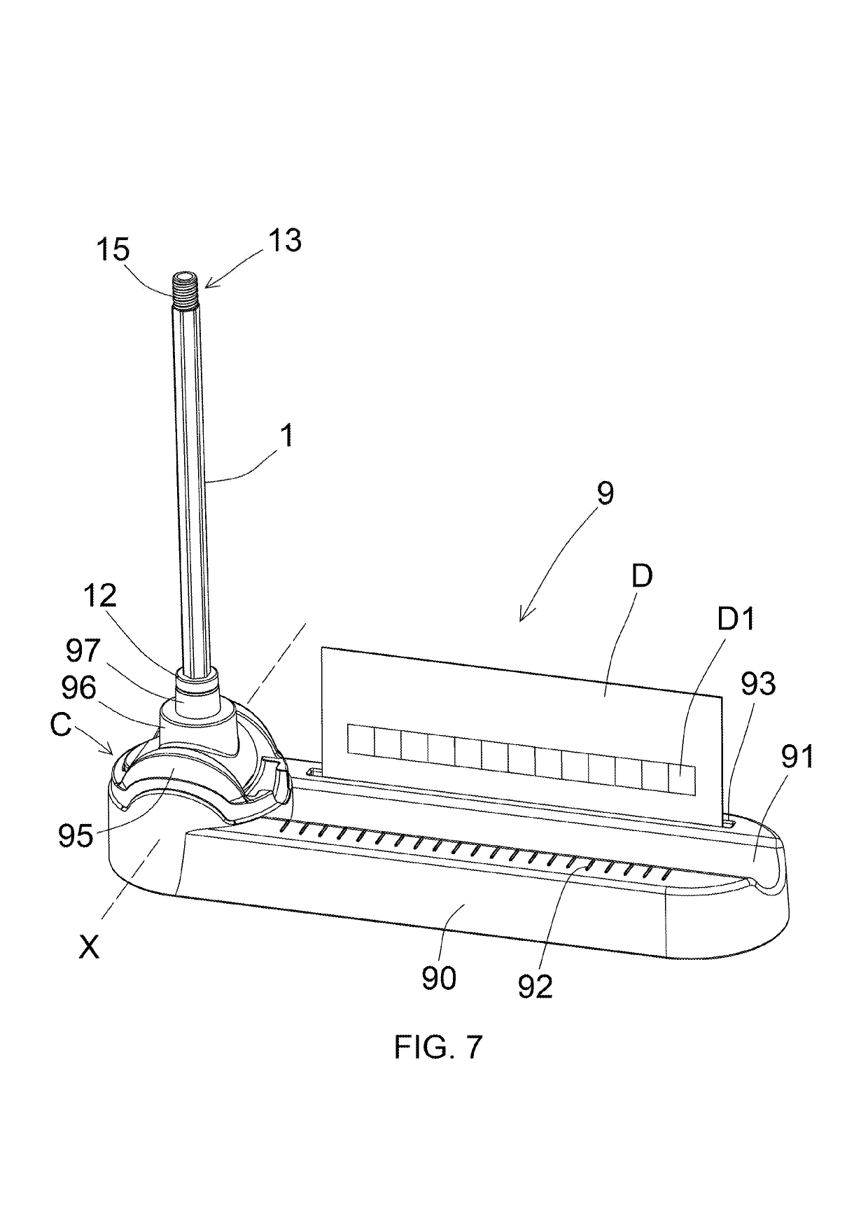

With reference to FIGS. 6 and 7, the workstation (9) comprises a base (90) suitable for resting on a horizontal plane. The base (90) can be mounted on anti-slip rubber feet (90a). The base (90) has a longitudinal groove (91) that defines a channel suitable for containing the shaft (1) of the stationery item.

A graduated scale (92) is disposed on the base (90) opposite the longitudinal groove (91). The graduated scale (92) may comprise marks that are equidistantly spaced from each other.

A grooved seat (93) is disposed on the base (90) behind the longitudinal groove (91).

The grooved seat (93) is suitable for accommodating a reference card (D) with a full-size pattern (D1) of recommended creations for the customization of the stationery items. The pattern (D1) of the reference card (D) shows the positions and types of decorative elements (8) to be fitted on the shaft (1) of the stationery item.

The reference card (D) has the shape of a rectangular panel that extends along the length of the longitudinal groove (91) and protrudes superiorly from the base (90) behind the longitudinal groove (91).

A wing (94) protrudes superiorly from the base (90) behind the grooved seat (93) to keep the reference card (D) in vertical position.

The workstation (9) comprises a hinge (C) for hinging a support (96) suitable for supporting the shaft (1) of the stationery item.

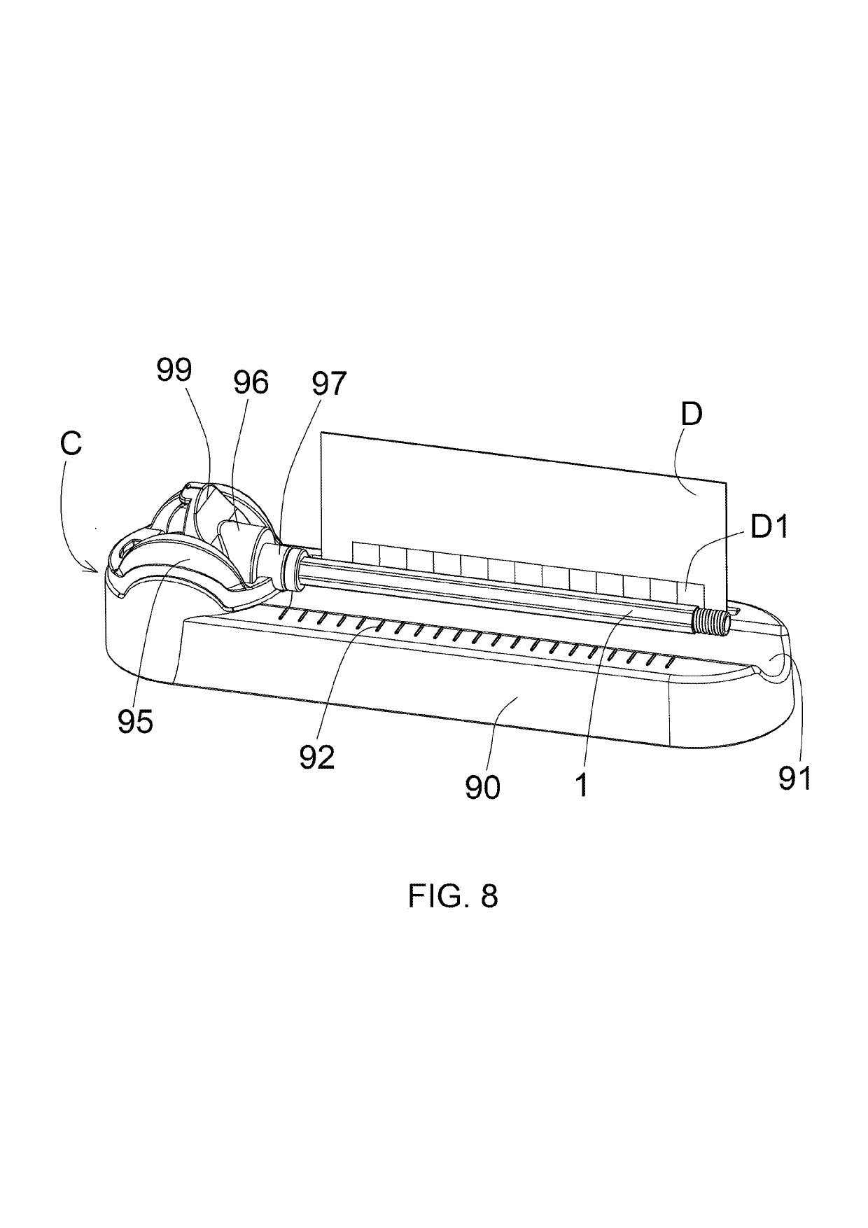

The hinge (C) has a horizontal axis (X) orthogonal to the longitudinal groove (91) of the base. In such a way, the shaft (1) supported by the support (96) can rotate from a vertical position (FIG. 7), wherein it protrudes orthogonally upward from the base (90), to a horizontal position (FIG. 8), wherein it is disposed horizontally above the longitudinal groove (91) of the base.

The hinge (C) comprises a fork (95) integral with the base and provided with seats (95a) wherein pins (96a) protruding from the support (96) are rotatably engaged.

The support (96) has a tang (97) having a radial axis with respect to the axis of the pins (96a). The tang (97) of the support is suitable for accommodating the front attachment (11) of the shaft of the stationery item. The tang (97) has an internal thread (98) into which the thread (14) of the front attachment (11) of the shaft of the stationery item is screwed.

The support (96) has a handle (99) that protrudes from the support in the opposite direction to the longitudinal groove (91) of the base, in such a way to be operated by the user to move the support (96).

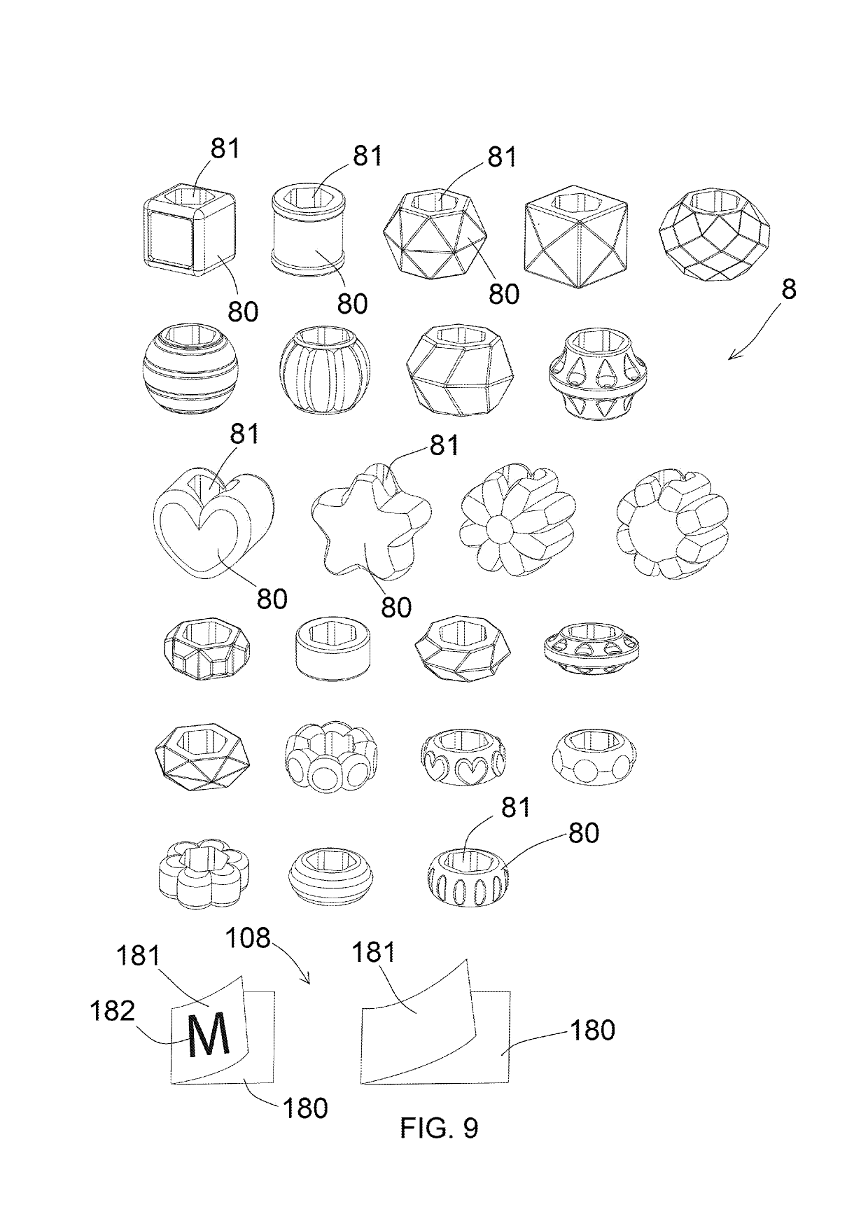

With reference to FIG. 9, the decorative elements (8) comprise a body (80) and a hole (81) suitable for being crossed by the shaft (1), so that the decorative elements (8) can be fitted onto the shaft (1). Advantageously, the hole (81) of each decorative element has a prismatic section in such a way to be coupled with the shaft (1) in prismatic coupling mode, preventing a relative rotation of the decorative element (8) with respect to the shaft (1).

For illustrative purposes, there may be decorative elements in the shape of a polyhedron, such as a cube, annular decorative elements with a rusticated, diamond-shaped, or ribbed external surface, cylindrical decorative elements, decorative elements in the shape of a star, heart, or flower.

Advantageously, the kit (100) further comprises stickers (108) suitable for being applied to the decorative elements (8) and also to the caps (110) and to the smooth surface (43) of the wing (42) of the pen.

Each sticker (108) comprises a substrate film (180) whereon an adhesive film (181) is arranged. The adhesive film (181) may have a letter or symbol (182). In any case, the adhesive film (181) may have different patterns.

The user removes the adhesive film (181) from the substrate film (180) and applies it on the decorative elements (8), on the second decorative elements (208), and also on the wing (42) of the pen. In particular, the adhesive film (181) can be applied to the flat faces of the polyhedral decorative element and to the smooth lateral surface of the cylindrical decorative element.

The decorative elements (8) can be disposed in the compartments (59) of the stand, the stickers can be disposed in the first module (107) of the stand, and the reference cards can be disposed in the seat (I) of the stand.

A possible use of the kit (100) is described below.

Firstly, the stationery item (A) to be customized is disassembled. Then the user takes the shaft (1) and fits it into the workstation (9), screwing the front attachment (11) of the shaft into the tang (97) of the support of the workstation, as shown in FIGS. 6 and 7. Successively, the user chooses the reference card (D) according to the type of customization to be performed, and inserts the reference card (D) into the grooved seat (93) of the base of the workstation.

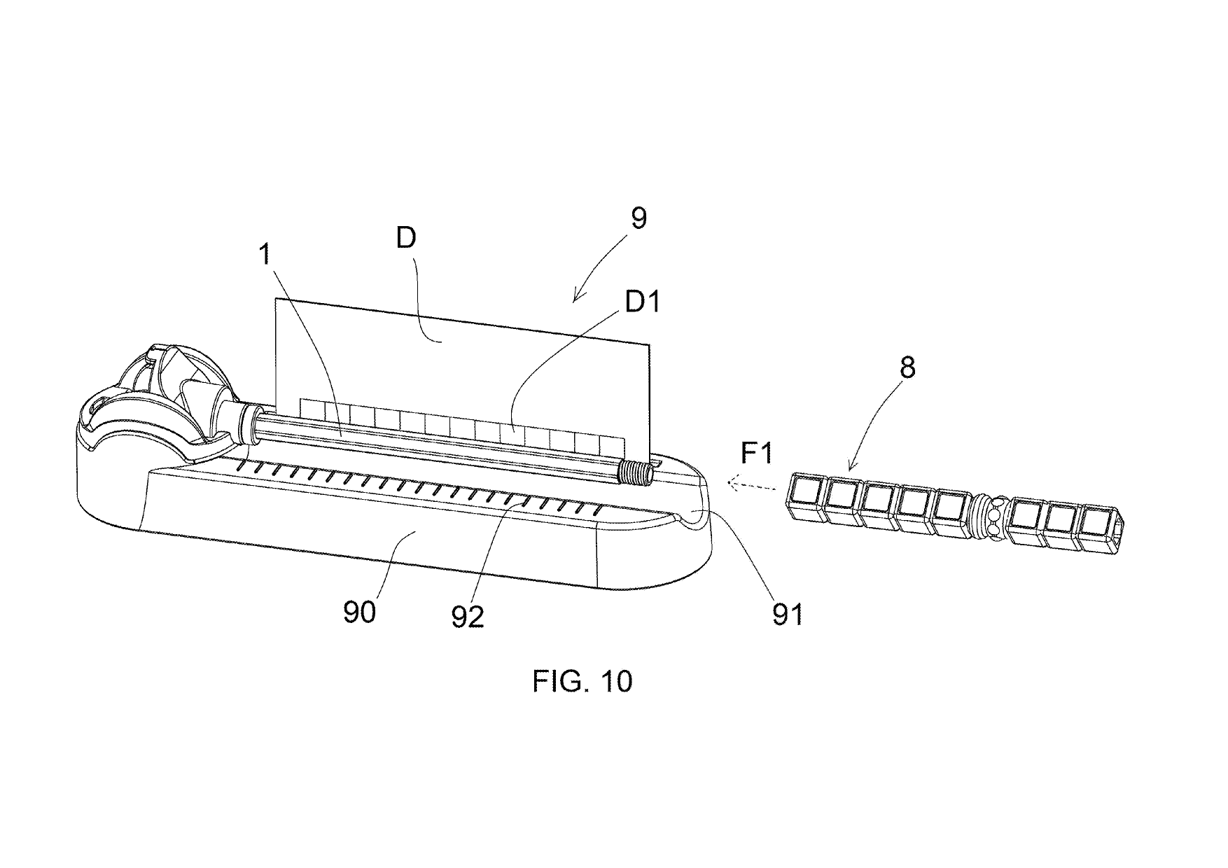

With reference to FIG. 10, the user places the shaft (1) in horizontal position and prepares the decorative elements (8) that are necessary for customization according to the indications contained in the pattern (D1) of the reference card (D).

It should be noted that the shaft (1) is positioned in front of the reference card (D) and the pattern (D1) of the reference card (D) indicates the decorative elements (8) to be used and their arrangement.

Now, the user fits the decorative elements (8) onto the shaft (1) in the direction of arrow F1, visually checking that their position corresponds to that shown in the pattern (D1) of the reference card (D). The assembly of the decorative elements is facilitated by the presence of the longitudinal groove (91) disposed in the base (90) under the shaft (1). In fact, the decorative elements (8) slide into the longitudinal groove (91).

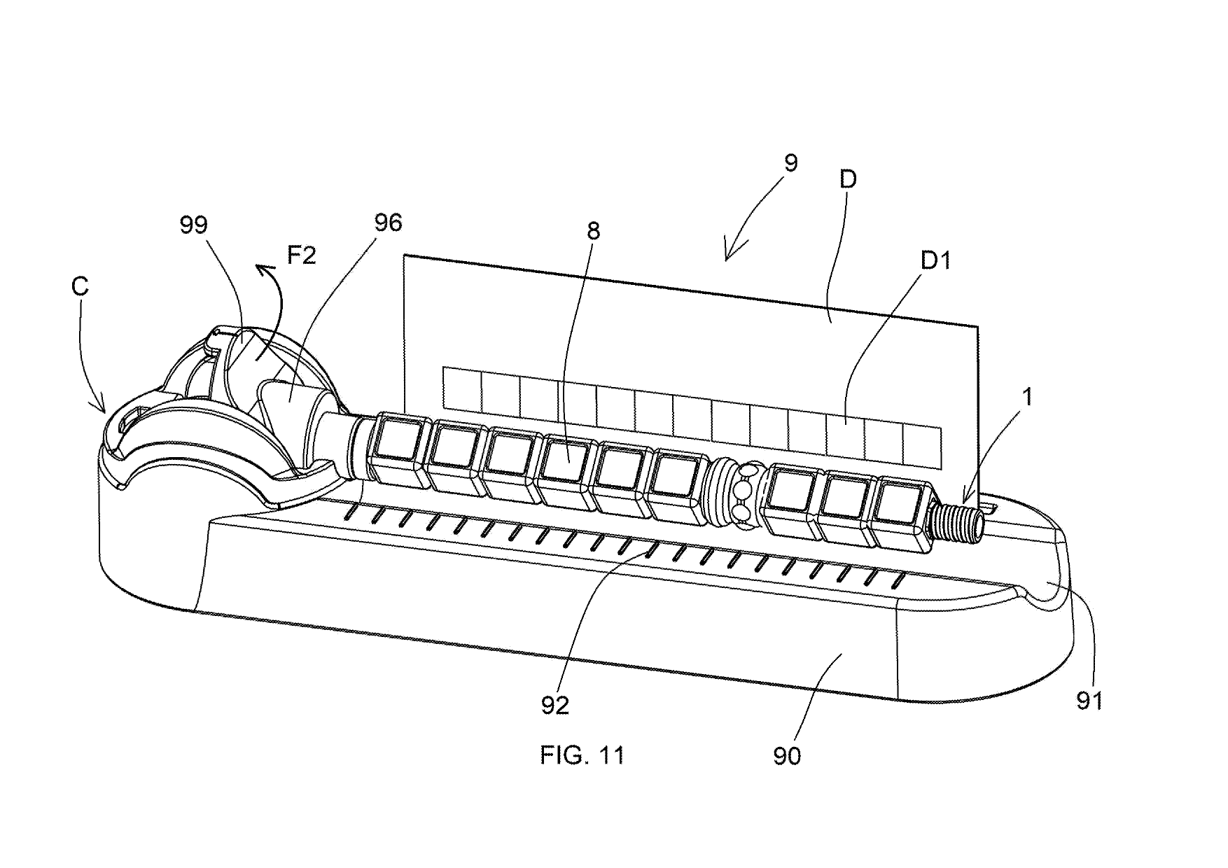

FIG. 11 illustrates the situation in which the decorative elements (8) are fitted on the shaft (1). Now, the user operates the handle (99) of the support (96) of the workstation, in such a way that the support (96) rotates around the axis of the hinge (C) and the shaft (1) with the decorative elements (8) is disposed in vertical position.

Evidently, the user may customize the stationery item without the aid of the reference card (D). In such a case, if the shaft (1) is in horizontal position, the user can use the graduated scale (92) as a reference for counting the decorative elements (8).

Alternatively, the shaft (1) can be disposed in the workstation (9) in vertical position and the decorative elements (8) are fitted onto the shaft in vertical position from up downward.

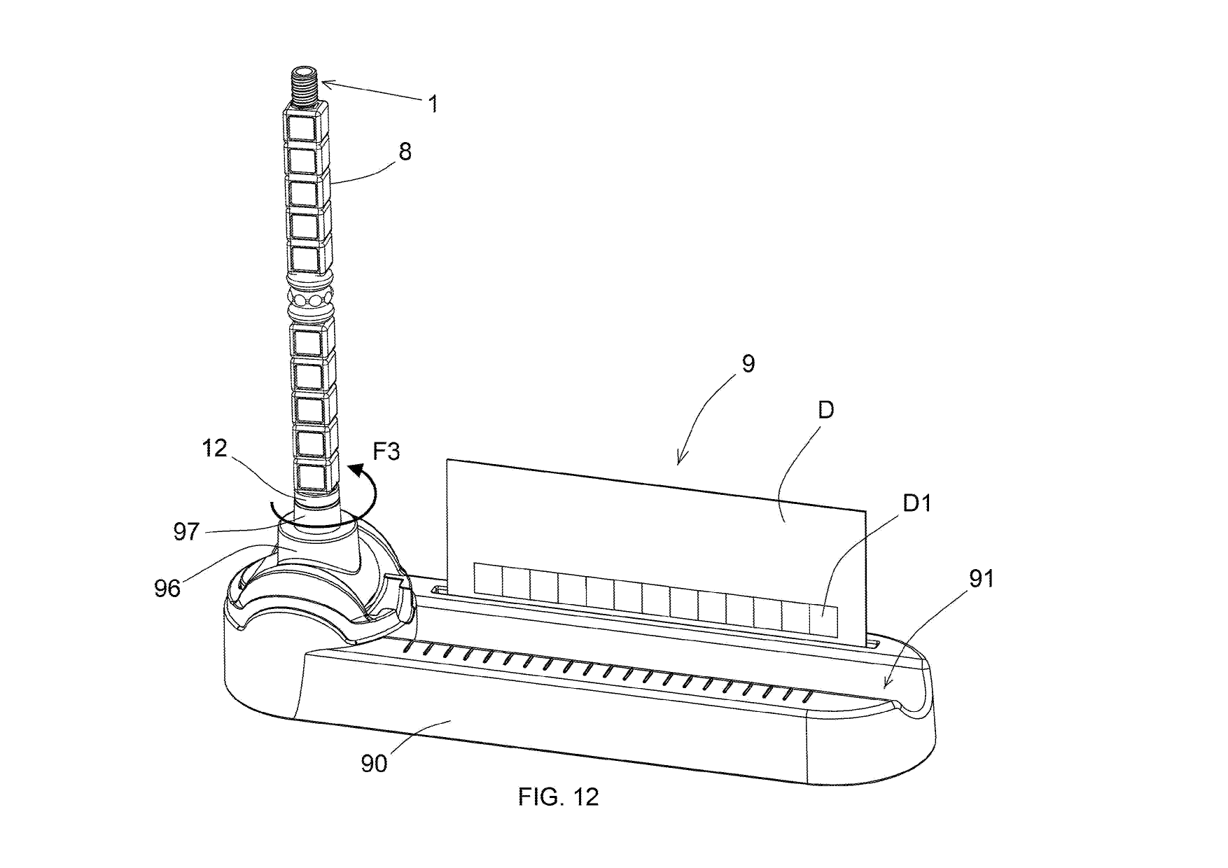

In any case, at the end of the assembly of the decorative elements, the shaft with the decorative elements is in vertical position in the workstation, as shown in FIG. 12. Now, the user rotates the shaft (1) in the direction of arrow F3, in such a way to unscrew the external thread (14) of the front attachment (11) of the shaft from the internal thread (98) of the tang (97) of the support of the workstation.

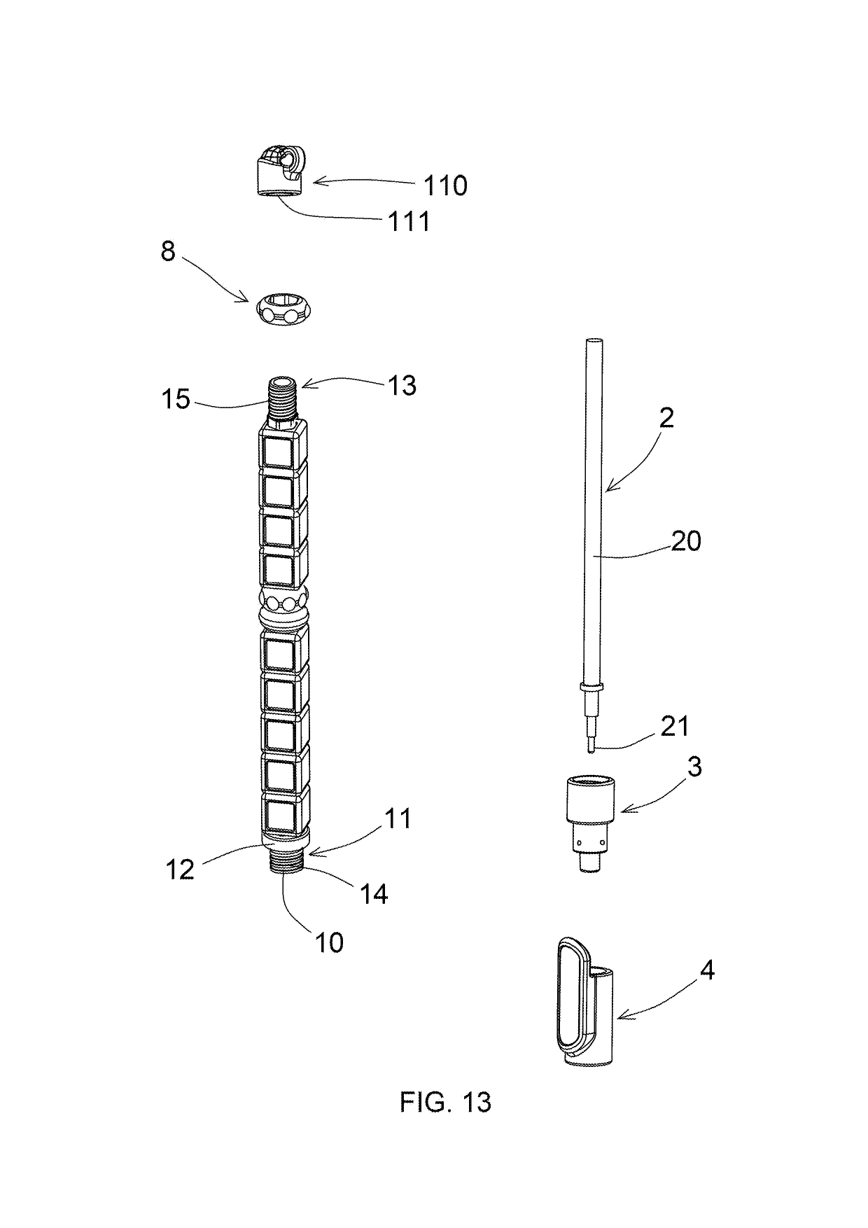

With reference to FIG. 13, the shaft (1) with the decorative elements (8) is removed from the workstation (9). Then the stationery item (A) is assembled by inserting the writing element (2) into the axial channel (10) of the shaft, screwing the retaining tip (3) to the front attachment (11) of the shaft, screwing the cap (110) to the rear attachment (13) of the shaft (1), and applying the plug (4) to the retaining tip (3).

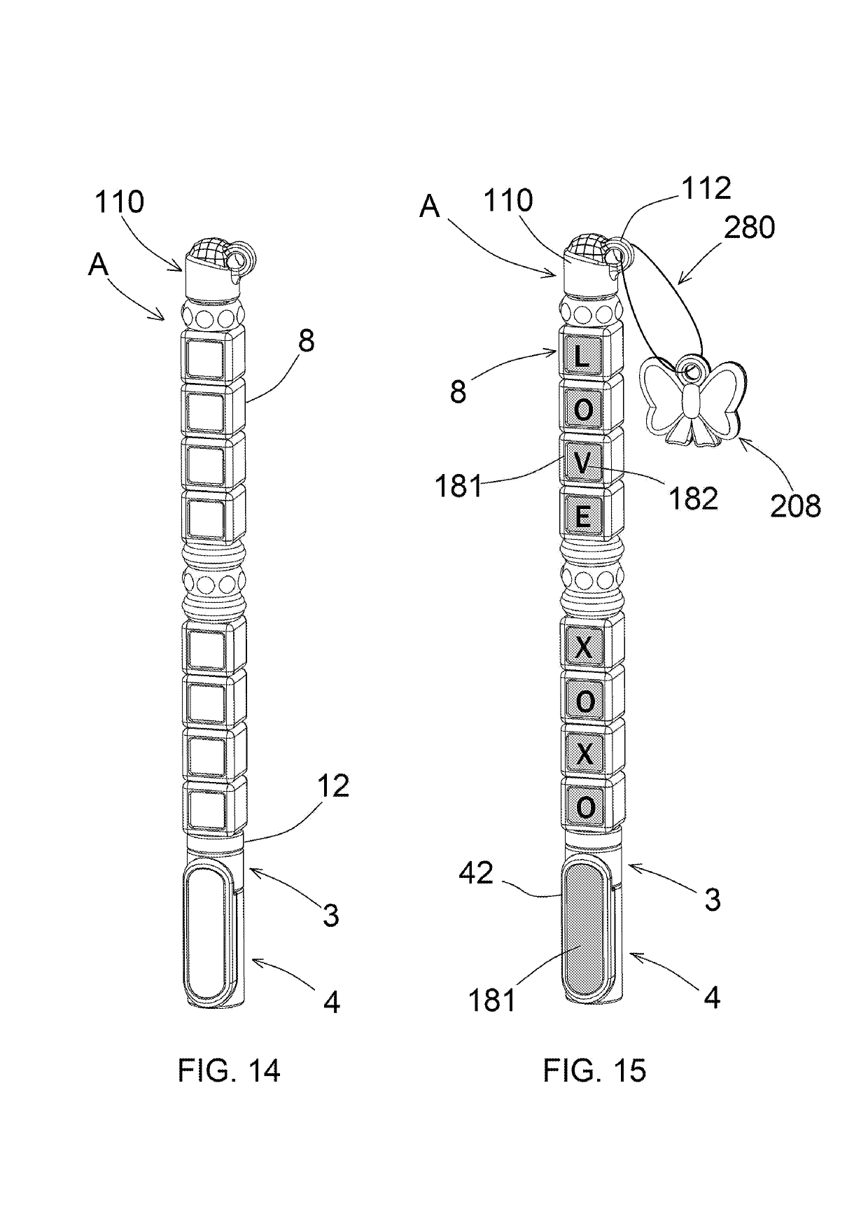

It should be noted that the collar (12) of the shaft acts as a front stop for the decorative elements and the cap (110) acts as a rear stop for the decorative elements. Therefore, the decorative elements (8) that are fitted onto the shaft (1) are held between the collar (12) of the shaft and the cap (110), as shown in FIG. 14.

With reference to FIG. 15, the stationery item (A) customized with the decorative elements (8) can be further customized using the stickers (108) and the second decorative elements (208). In particular, adhesive films (181) with a letter (182) are applied to the flat faces of cubic decorative elements in such a way to compose a name, word, or phrase. A colored adhesive film (181) is applied to the smooth surface of the wing (42) of the cap. The loop-shaped thread (280) of a second decorative element (208) is coupled to the fastening means (112) of the cap (110).

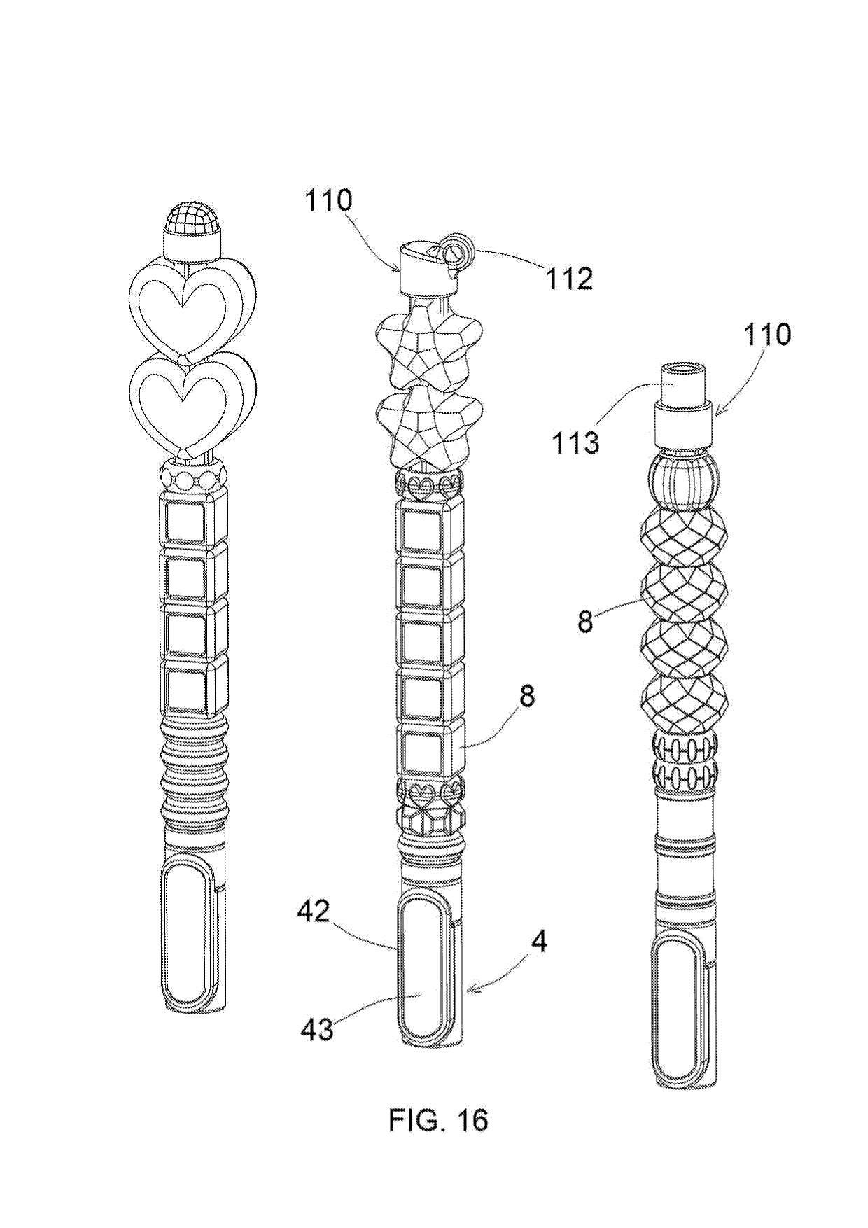

FIG. 16 illustrates three different possible customization examples of stationery items (A) with decorative elements (8) of different types.

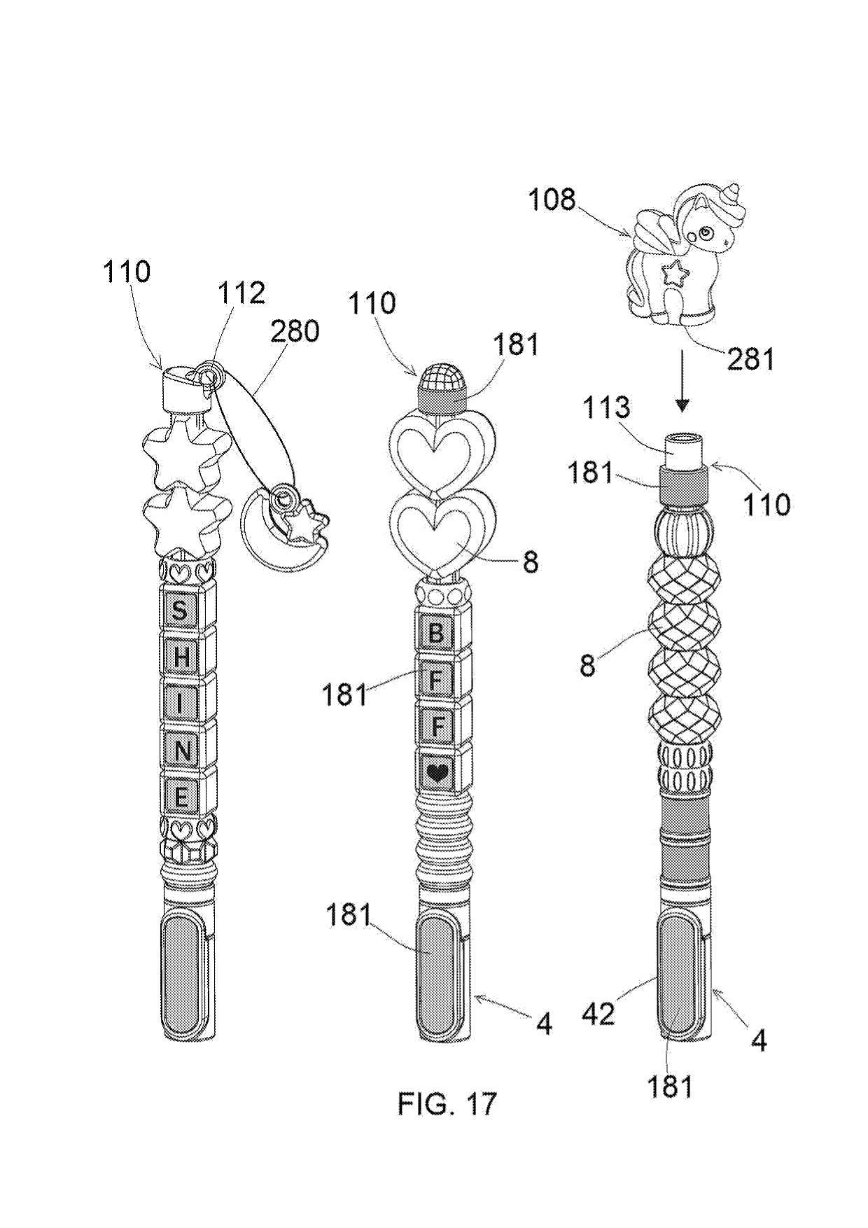

FIG. 17 illustrates the three examples of stationery items (A) of FIG. 15 that have been further customized, wherein adhesive films (181) of the stickers (108) are applied to smooth surfaces of some decorative elements (8), on smooth surfaces of caps (110) and on the smooth surface of the wing (42) of the plug. In addition, second decorative elements (208) are connected to the caps (110) of two stationery items.

Numerous modifications can be made to the present embodiment of the invention, which are within the reach of an expert of the field and fall in any case within the scope of the invention as disclosed by the attached claims.

1. A kit comprising:
a plurality of stationery items comprising a shaft;
a plurality of decorative elements comprising a body and a hole suitable for being fitted onto said shaft of the stationery items so as to customize said stationery item;
a workstation configured in such a way to support said shaft of the stationery item for assembling the decorative elements on the shaft of the stationery item; and
a stand for displaying and containing said customized items and said decorative elements.

2. The kit of claim 1, wherein said workstation comprises:
a base suitable for being disposed on a horizontal surface;
a support suitable for supporting the shaft of the stationery item; and
a hinge that hinges the support to the base, said hinge having a horizontal axis so that the shaft supported by the support can rotate from a vertical position, wherein it protrudes orthogonally upward from the base, to a horizontal position, wherein it is disposed horizontally above the base.

3. The kit of claim 2, wherein said base has a longitudinal groove that defines a channel suitable for accommodating the shaft of the stationery item and said horizontal axis of the hinge is orthogonal to said longitudinal groove of the base and when the shaft is in the horizontal position, it is disposed above said longitudinal groove.

4. The kit of claim 3, wherein said base comprises a grooved seat disposed behind the longitudinal groove, and said kit further comprises at least one reference card containing a full-size pattern of recommended creations for the customization of the stationery items.

5. The kit of claim 3, wherein said base comprises a graduated scale disposed in front of the longitudinal groove.

6. The kit of claim 2, wherein said support of the workstation has a tang suitable for being removably coupled with a front attachment of said shaft of the stationery item.

7. The kit of claim 1, wherein said shaft has an axial channel and said stationery item comprises a writing element having a body suitable for being disposed in said axial channel of the shaft, and a writing tip that leaves a trace on the surface when it is rested on a surface.

8. The kit of claim 1, wherein said stationery item further comprises:
a retaining tip that can be fitted on a front part of the shaft to retain said writing element;
a cap that can be fitted on a rear part of the shaft; and
a plug that can be fitted on the retaining tip.

9. The kit of claim 1, wherein said shaft has a prismatic cross-section and said hole 81) of each decorative element has a prismatic cross-section in such a way to be coupled with the shaft in prismatic coupling mode.

10. The kit of claim 1, further comprising stickers suitable for being applied on the decorative elements and/or on parts of said stationery items.

11. The kit of claim 4, further comprising stickers suitable for being applied on the decorative elements and/or on parts of said stationery items.

12. The kit of claim 11, wherein said stand comprises a base and a first module, a second module and a third module assembled on the base, said base comprising:
a bottom in the shape of a semicircle;
a front wall rising from the bottom;
a first support block with engagement seats, a second support block with engagement seats, and a central support block arranged peripherally on the bottom;
a plurality of compartments to accommodate said decorative elements disposed between said front wall and said support blocks;
said first module comprising a roller rotatably mounted in a lid disposed in said base, said roller being suitable for supporting said stickers in such a way to form a roll;
said second module being shaped like a bridge disposed on said first support block and having a platform with holes for the insertion of said decorated stationery items;
said third module being shaped like a bridge disposed on said second support block and having a platform with holes for the insertion of said decorated stationery items; and
a seat suitable for housing said reference cards being provided on said central support block between said first and second support blocks.

13. The kit of claim 8, further comprising second decorative elements comprising a loop-shaped thread that is fastened with fastening means of said cap of the stationery item.

14. The kit of claim 8, further comprising second decorative elements comprising coupling means engaged with coupling means of said cap of the stationery item.
